(19) United States
(12) Patent Application Publication
(10) Pub. No.: US 2008/0113656 A1
(43) Pub. Date: May 15, 2008

(54) SYSTEM AND METHOD FOR UPDATING CONTENTS

(75) Inventors: Seung Yop Lee, Namyangju-si (KR); Jong Min Lee, Seoul (KR)

Correspondence Address: PEARNE & GORDON LLP, 1801 EAST 9TH STREET, SUITE 1200, CLEVELAND, OH, 44114-3108, US

(73) Assignee: LG TELECOM LTD., Seoul (KR)

(21) Appl. No.: 11/938,375

(22) Filed: Nov. 12, 2007

(30) Foreign Application Priority Data
Nov. 15, 2006 (KR) 10-2006-0112979
Mar. 16, 2007 (KR) 10-2007-0026333

(51) Int. Cl. H04Q 7/22

(52) U.S. Cl. 455/414.3

(57) ABSTRACT

A method and system for updating contents is provided. According to the method and system for updating the contents, a content provision server determines scheduling of update time information, which is classified by each member, and transmits the update time information to each mobile terminal of each member, and the mobile terminal transmits an update request signal to the content provision server based on the update time information, and receives update information from the content provision server.

### CROSS-REFERENCE TO RELATED APPLICATIONS

This application claims the benefit of Korean Patent Application No. 10-2006-0112979, filed on Nov. 15, 2006, in the Korean Intellectual Property Office, and Korean Patent Application No. 10-2007-0026333, filed on Mar. 16, 2007, in the Korean Intellectual Property Office, the disclosure of both of which are incorporated herein by reference.

### BACKGROUND OF THE INVENTION

1. Field of the Invention

The present invention relates to a method and system for updating contents which enables a content provision server to determine scheduling of update time information, which is classified by each member, and to transmit the update time information to each mobile terminal of each member, and enables the mobile terminal to transmit an update request signal to the content provision server based on the update time information, and to receive update information from the content provision server. Also, the present invention relates to a system for updating contents including a mobile terminal, and more particularly, to a method and system for updating contents which includes update time information data when releasing the mobile terminal in a market, accesses a predetermined server based on the update time information, and receives content information.

2. Description of Related Art

As a mobile terminal is widely popularized, technologies related to this field are being developed, and various functions are added daily due to various needs of consumers and competitions between enterprises. Accordingly, communication providers and terminal providers provide members with various applications and information, requested by the members, via a wired/wireless network. Provision of interest information directly established by a member, such as e-commerce information via the wireless Internet, stock information, and a Global Positioning System (GPS)-based data service, are representative examples of the various applications and information. Accordingly, the member may refer to information corresponding to the member's interest via the wired/wireless network using the member's own mobile terminal, or download corresponding information from a server providing the corresponding information.

However, the member is required to access the server providing the corresponding information using a consecutive input process each time in order to receive update information using the above-described conventional method. Also, after accessing the server, the member requires a consecutive process of searching for the information required for the member and receiving the update information with respect to the retrieved information. Accordingly, the above-described conventional method has an inconvenience in which the consecutive input process is required for each access, and a disadvantage in which a download speed of the corresponding information is reduced when an overload exists in a corresponding network, and the member is required to additionally pay for additional communication costs due to the reduction of the download speed.

### BRIEF SUMMARY

An aspect of the present invention provides a method and system for updating contents which enables a mobile terminal to transmit an update request signal to a content provision server based on update time information, and to receive update information from the content provision server when the update time information is determined scheduling which is classified by each member, and is transmitted to each mobile terminal of each member in order to efficiently update the contents.

An aspect of the present invention also provides a method and system for updating contents which enables a content provision server to determine scheduling of a time of transmitting updated contents to each member, and to transmit the updated content information to a mobile terminal of the member based on the time, the time being determined scheduling, in order to effectively use a mobile network.

An aspect of the present invention also provides a method and system for updating contents which can check a content update time via an application and transmit an update request signal to a content provision server when the update time occurs in order to increase a member's convenience when using a mobile terminal.

An aspect of the present invention also provides a method and system for updating contents which can provide a member interface displaying content information on a mobile terminal using update information and template information of the content information.

An aspect of the present invention also provides a mobile terminal which can store update information from a point in time of releasing the mobile terminal to market, and a method and system for updating contents which can provide the mobile terminal with the update information.

An aspect of the present invention also provides a mobile terminal which can perform a stable update using a synchronization process between the mobile terminal and a server.

An aspect of the present invention also provides a mobile terminal which can automatically perform a stable update based on stored update time information eliminating a need for a consecutive input process in order to access a server for providing corresponding information, and a method and system for updating contents which can provide the mobile terminal with update information.

According to an aspect of the present invention, there is provided a mobile terminal, the mobile terminal including: a wireless transceiving module to transmit an update request signal to a predetermined server and receive content information from the server; a storage module to store update time information for accessing the server and the content information received from the server; and a control module to control the mobile terminal to access the server based on the update time information stored in the storage module, and to receive the content information.

According to another aspect of the present invention, there is provided a system for updating contents, the system including: a mobile terminal to transmit an update request signal to a predetermined server based on update time information, and to receive, from the server, content information corresponding to the update request signal; and a server to package the content information corresponding to the update request signal and transmit the content information to the mobile terminal.

According to still another aspect of the present invention, there is provided a server for providing content information to at least one member mobile terminal, the server including: a content provision module to provide update detail information; a packaging module to package the content information which includes update type information and the update detail information; and a control unit to control the server to transmit the packaged content information to the mobile terminal, wherein the mobile terminal transmits an update request signal to the server based on update time information, and the server transmits, to the mobile terminal, the content information corresponding to the update request signal.

According to further another aspect of the present invention, there is provided a method of updating contents of a mobile terminal, the method including: setting a predetermined server and session based on update time information and transmitting an update request signal by the mobile terminal; packaging, by the server, content information corresponding to the update request signal, and transmitting, from the server, the content information to the mobile terminal; receiving and storing the content information corresponding to the update request signal by the mobile terminal; and displaying the stored content information.

Additional aspects, features, and/or advantages of the invention will be set forth in part in the description which follows and, in part, will be apparent from the description, or may be learned by practice of the invention.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates an entire network connection of a system for updating contents according to an exemplary embodiment of the present invention;

FIG. 2 is a block diagram illustrating a system for updating contents according to an exemplary embodiment of the present invention;

FIG. 3 illustrates an example of content information transmission according to an exemplary embodiment of the present invention;

FIG. 4 illustrates an example of content display screens according to an exemplary embodiment of the present invention;

FIG. 5 is a flowchart illustrating a method of updating contents according to an exemplary embodiment of the present invention;

FIG. 6 is a block diagram illustrating a system for updating contents including a mobile terminal and a server for providing an update function according to another exemplary embodiment of the present invention;

FIG. 7 is a flowchart illustrating a method of updating contents realized in a mobile terminal according to a first exemplary embodiment of the present invention;

FIG. 8 is a flowchart illustrating a method of updating contents realized in a mobile terminal according to a second exemplary embodiment of the present invention;

FIG. 9 is a flowchart illustrating a method of updating contents realized in a mobile terminal according to a third exemplary embodiment of the present invention;

FIG. 10 is a table illustrating update time information including at least one piece of time information according to an exemplary embodiment of the present invention;

FIG. 11 is a flowchart illustrating a process of transceiving information between a mobile terminal and a server based on update time information according to an exemplary embodiment of the present invention;

FIG. 12 is a table illustrating reservation variables for synchronization between a mobile terminal and a server for a reattempt when the mobile terminal fails in an access to the server according to an exemplary embodiment of the present invention;

FIG. 13 illustrates a process of performing a synchronization between a mobile terminal and a server for a reattempt when the mobile terminal fails in an access to the server according to an exemplary embodiment of the present invention; and

FIG. 14 is a block diagram illustrating components of a server according to an exemplary embodiment of the present invention.

### DETAILED DESCRIPTION OF EMBODIMENTS

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

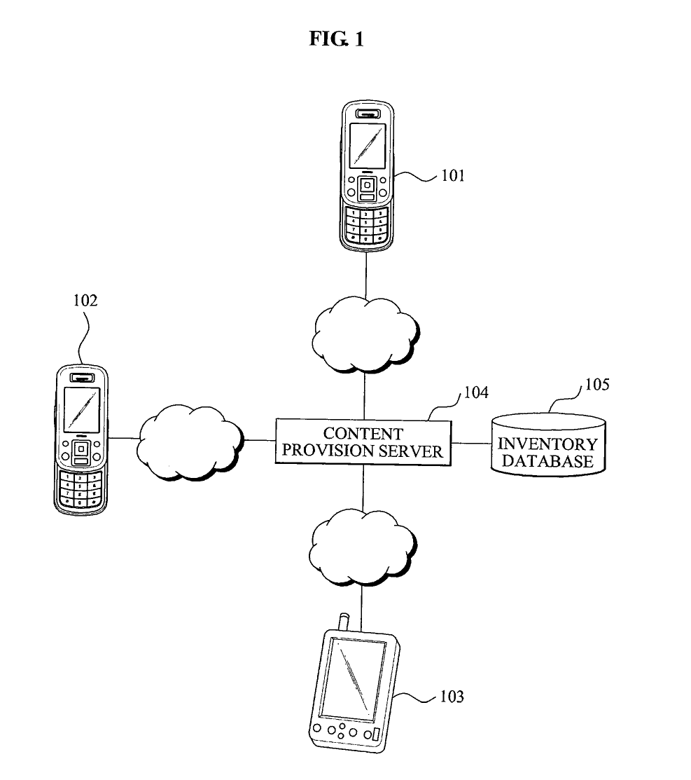

FIG. 1 illustrates an entire network connection of a system for updating contents according to an exemplary embodiment of the present invention.

As illustrated in FIG. 1, the system for updating the contents according to the present invention may be realized in at least one of mobile terminals 101 through 103, and a content provision server 104. FIGS. 1 through 5 limitedly illustrate that the system for updating the contents according to the present invention is realized in a content provision server for convenience of description.

First, the content provision server 104 receives, from the mobile terminals 101 through 103, a selection of content information to be updated. Specifically, the content provision server 104 performs a service registration for a member of the mobile terminal 101 in order to realize an update of the content information according to the present invention. In a process of the service registration, the member may individually select a type of the content information to be displayed (or to be updated), and the content provision server 104 may register the member selecting the content information as a service member. For example, the member may select and designate a bundle of content types previously suggested by a salesman, thereby selecting the content information. The service registration process may be performed by at least one of Wireless Application Protocol (WAP) and a terminal manager application installed in the mobile terminal the mobile terminal is described below.

Also, the content provision server 104 determines scheduling of update time information, which is classified by the member, and transmits, to the mobile terminals 101 through 103 of each member, the update time information being the determined scheduling. Specifically, the content provision server 104 recognizes the update time information related to the content information selected by the service-registered member, and transmits the update time information to the corresponding mobile terminals 101 through 103. The update time information may denote a time of transmitting the updated content information when contents desired by the member are updated, and may be variously set for each member.

For example, the content provision server 104 may classify each member into at least two groups, and variously set the update time information for each group. When the mobile terminal 101 is a first group, the mobile terminal 102 is a second group, and the mobile terminal 103 is a third group, the update time information of the first group may be set as “9:00”, the update time information of the second group may be set as “9:10”, and the update time information of the third group may be set as “9:20”. In this case, the update time information of the mobile terminal 101 included in the first group is set as “9:00”, the update time information of the mobile terminal 102 included in the second group is set as “9:10”, and the update time information of the mobile terminal 103 included in the third group is set as “9:20”.

The mobile terminals 101 through 103 receive the update time information from the content provision server 104, and store the update time information in a predetermined storage unit. Also, the mobile terminals 101 through 103 check whether a signal transmission time occurs based on the update time information stored in the storage unit. When the signal transmission time occurs, the mobile terminals 101 through 103 generate an update request signal and transmit the update request signal to the content provision server 104. According to another exemplary embodiment of the present invention, the mobile terminals 101 through 103 may receive the update time information from the member, and store the update time information in the storage unit.

The content provision server 104 receives the update request signal from the mobile terminals 101 through 103, identifies the content information from an inventory database 105, and transmits the content information to the mobile terminals 101 through 103. The update time information which is classified by each member and the content information corresponding to inventory information may be stored in the inventory database 105. Also, the content information includes update information and template information.

According to the present exemplary embodiment of the present invention, the mobile terminals 101 through 103 may transmit the update request signal including the inventory information to the content provision server. Accordingly, the content provision server 104 may search for the transmitted update time information and the content information corresponding to the received inventory information from the inventory database 105, and transmit the update time information and the content information to each mobile terminal 101 through 103.

As describe above, a system for updating contents according to the present invention enables a mobile terminal to transmit an update request signal to a content provision server based on update time information, and to receive update information from the content provision server when the update time information is determined scheduling which is classified by each member, and is transmitted to each mobile terminal of each member, thereby efficiently updating the contents.

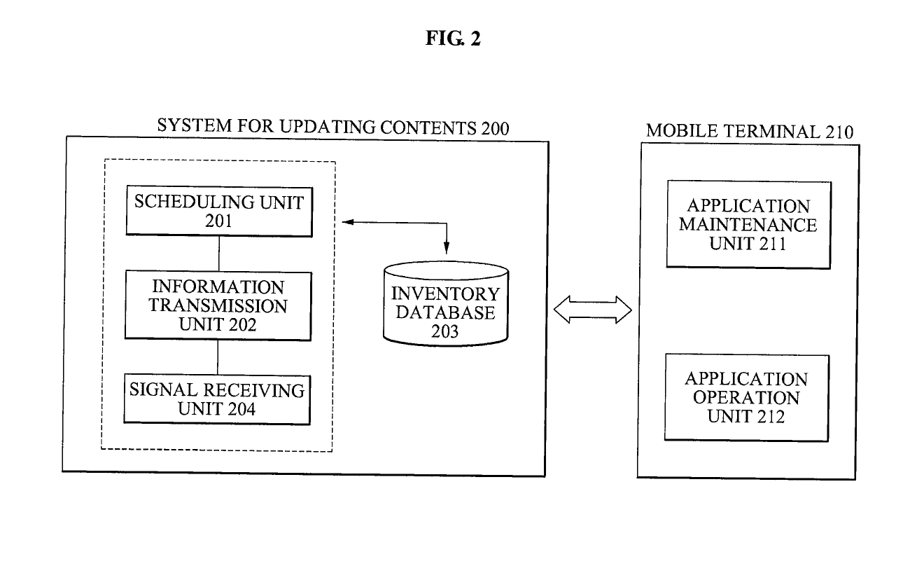

Hereinafter, a system 200 for updating contents is described in detail with reference to FIG. 2.

As illustrated in FIG. 2, the system 200 for updating the contents includes a scheduling unit 201, an information transmission unit 202, an inventory database 203, and a signal receiving unit 204, and may be realized in the content provision server 104 of FIG. 1. Also, a mobile terminal 210 includes an application maintenance unit 211 and an application operation unit 212. Accordingly, the mobile terminal 210 drives a predetermined terminal manager application, and performs any one of displaying a graphic of the content information transmitted from the content provision server 104, and processing a generated event when displaying the content information.

First, the scheduling unit 201 determines scheduling of update time information which is classified by a member. The member is a member of a content update service, and registers a telephone number of the member's own mobile terminal in the system 200 for updating the contents in order to receive the updated contents. Also, the update time information is a time related to transmitting the updated contents to each mobile terminal of each member, and the scheduling unit 201 may classify the member into at least two groups, and variously set the update time information for each group.

As described above, a system for updating contents according to the present invention enables a content provision server to determine scheduling of a time of transmitting updated contents to each member, and to transmit the updated content information to a mobile terminal of the member based on the time being determined scheduling, thereby effectively using a mobile network.

Also, according to the present invention, the update time information includes at least one of an update starting time, an update completion time, a standard time, a delay time from the standard time, and an update interval.

The update starting time includes information of an update execution starting time, and the update completion time includes information of an update execution completion time. Also, the standard time denotes a time being a standard of an update execution, and the delay time denotes a delay time which an update is executed from the standard time. Also, the update interval denotes an interval between an update execution and a subsequent update execution.

The standard time is information of a time in which the update is executed. Specifically, the standard time may be calculated based on the update starting time, the update interval, the delay time, the update completion time, and the like set in the update time information. For example, when the update starting time is set as “9:00” daily, and the update interval is set as two hours, the initial standard time is “9:00”. As the update is progressed, subsequent standard times may be set as two-hour intervals from the initial starting time, for example, “11:00”, “13:00”, and the like, with reference to the update interval.

The delay time is information of delaying the update execution during a time set from the calculated standard time, and when the mobile terminal is released in a market, the delay time may be generally set as 0 (zero). However, the delay time may be changed via a predetermined control module. The delay time may flexibly set an access time to the content provision server 104 which is classified by the member in order to distribute traffic of the content provision server 104 as the number of members increases. In the above-described example, when the delay time is set as five minutes, the initial standard time may be “9:05”, and the subsequent standard times may be “11:05”, “13:05”, and the like.

By comparing the standard time with the update completion time, the system may be controlled to not execute the update after the update completion time.

As described above, a change of the standard time may be performed with reference to the update time information stored in the mobile terminal, or be set by receiving, from the content provision server 104, information related to the subsequent standard time with the updated content information. When the information related to the standard time is used, the content provision server 104 may control a server access time which is classified by the member as the above-described delay time considering the traffic.

As described above, the set update time information is stored in the inventory database 203. Specifically, the inventory database 203 stores the content information corresponding to the update time information which is classified by each member.

The content information includes update information and template information. Also, the update information is changed at each update of the content information, and the template information is a basic structure configuring the content information, and is maintained for each update of the content information. For example, when weather information is provided in real-time, the information changed at any time, such as current weather of a specific area, is the update information, and a portion unchanged at any time, such as a background of a screen and a basic menu, is the template information.

Specifically, the update information includes update type information and update detail information. The update type information is information of a type of information to be updated, and is information of a type of content which classifies information provided for the member, such as a stock and news. Also, the update detail information is detail information provided for the member of the mobile terminal, and includes various forms based on the update type and an output type, for example, a text file (TXT), an image file (IMG), and the like.

According to the present exemplary embodiment of the present invention, the inventory database 203 further includes inventory information corresponding to the content information. The inventory information includes a sequence corresponding to the update information in the content information. The inventory information manages the update between the content provision server 104 and the mobile terminal 210. Specifically, the system 200 for updating the contents according to the present invention compares the inventory information received from the mobile terminal 210 with the inventory information stored in the content provision server 104, and determines whether the content information included in the mobile terminal 210 is up-to-date information. When the content information is out-of-date information, the system 200 for updating the contents may control the content provision server 104 so that the up-to-date content information may be transmitted to the corresponding terminal 210.

As described above, the inventory information is information which enables the content information to be transmitted to the mobile terminal 210 only when the requested content information is determined to actually require updating, in order to reduce wastes caused by such things as a traffic increase and resource utilization generated since the content provision server 104 does not automatically transmit the content information to the mobile terminal 210 when the update is requested from the mobile terminal 210.

Specifically, when the information managed by the content provision server 104 is updated, the content provision server 104 generates the corresponding inventory information by establishing, as a package object, the update detail information which is classified by the update type updated during a predetermined time, and stores the inventory information in the inventory database 203. The inventory information may be a sequence corresponding to the update detail information updated based on a package sequence.

When the inventory information is shown as the sequence, the system 200 for updating the contents compares the sequence stored in the mobile terminal 210 with the sequence stored in the content provision server 104. The system 200 for updating the contents packages the update detail information which is classified by the update type corresponding to the up-to-date sequence from the subsequent sequence of the sequence stored in the mobile terminal 210, and transmits, to the mobile terminal 210, the packaged content information, that is, the update information and the template information. The sequence may include the update time information of which the content information is transmitted to the mobile terminal 210. In this case, the sequence may be classified by an update time.

The information transmission unit 202 transmits the update time information to the mobile terminal 210. The information transmission unit 202 may transmit the update time information to each mobile terminal of each member with reference to the inventory database 203. As the update time information is received, the mobile terminal 210 may store the received update time information in a predetermined storage unit. According to another exemplary embodiment of the present invention, the mobile terminal 210 may receive the update time information from the member and store the update time information in the storage unit. The update time information inputted by the member may determine scheduling by using a method identical to the method of determining update time information, the update time information being determined scheduling in the content provision server 104.

The signal receiving unit 204 receives an update request signal from the mobile terminal 210 at a predetermined point in time based on the transmitted update time information. For example, when the update time information is set as “9:00”, the mobile terminal 210 generates the update request signal at “9:00”, and the signal receiving unit 204 receives the generated update request signal. Therefore, according to the present invention, the contents may be updated by the update time information stored in the mobile terminal 210 eliminating a need for a separate key operation, and the member of the mobile terminal 210 may conveniently realize the update.

In this instance, the mobile terminal 210 checks whether a signal transmission time occurs based on the update time information received from the content provision server 104 and stored in the storage unit, and when it is determined that the signal transmission time occurs, the mobile terminal 210 generates the update request signal, and transmits the update request signal to the content provision server 104.

Subsequently, the information transmission unit 202 enables contents to be updated in the mobile terminal 210 by transmitting the retrieved content information in response to the inputted update request signal. Specifically, when the update request signal is received from the mobile terminal 210, the information transmission unit 202 identifies, from the inventory database 203, the content information corresponding to the update request signal, and transmits the identified content information to the mobile terminal 210.

In this instance, the information transmission unit 202 may identify the content information from the above-described inventory database 203 with reference to the inventory information received with the update request signal. The mobile terminal 210 updates the content information by receiving the identified content information from the content provision server 104 and storing the content information.

In this instance, the mobile terminal 210 drives a predetermined terminal manager application, and performs any one of displaying a graphic of the content information transmitted from the content provision server 104, and processing a generated event when displaying the content information.

The application maintenance unit 211 included in the mobile terminal 210 manages the terminal manager application related to execution of the content information.

Also, the application operation unit 212 of the mobile terminal 210 drives the terminal manager application, executes the content information, and performs any one of processing the generated event and processing the graphic of the content information, when executing the content information.

The terminal manager application of the present invention may process the graphic of the content information, and perform any one of configuring a screen and displaying the graphic, and participating in the generated event processing when displaying the contents. The terminal manager application can be any one of driven software of the mobile terminal interoperating with receiving the content information, and software always operated with basic software of the mobile terminal. For example, the terminal manager application of the always-operated software monitors the update time information of the mobile terminal, and participates in an overall display of the stored content information when the content information request to the system 200 for updating the contents, the content information receiving and update, or the predetermined generated event of the mobile terminal, exists.

For example, when the event, in which the member requests additional information, is generated when executing the content information in a waiting screen, the terminal manager application performs any one of changing the waiting screen and downloading and displaying the additional information, and completing the execution when a call connection event is generated. Also, the terminal manager application may execute the transmitted content information operating the basic software related to a basic operation of the mobile terminal.

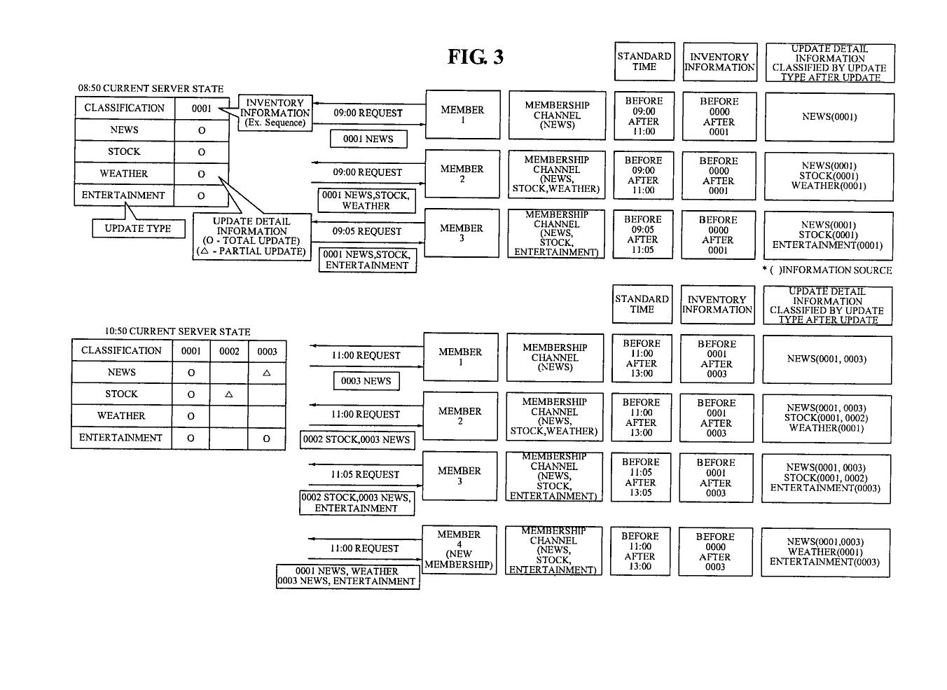

Hereinafter, an example of content information transmission is described with reference to FIG. 3.

As illustrated in FIG. 3, the content provision server 104 may store update type information/update detail information and inventory information in the content information corresponding to the current server state. The update detail information is an update method, for example, any one of a total update (◯) and a partial update (Δ). Also, the inventory information includes a sequence corresponding to the update detail information.

For example, when it is currently “8:50”, the system 200 for updating the contents according to the present invention may receive an update request signal for a first member at “9:00”, and transmit the content information with respect to “0001 news” (the total update (◯)) to the mobile terminal 210 of the first member. Also, the system 200 for updating the contents may receive the update request signal for a second member at “9:00”, and transmit the content information with respect to “0001 news, a stock, and weather” (the total update (◯)) to the mobile terminal 210 of the second member.

Also, when it is currently “10:50”, the system 200 for updating the contents according to the present invention may receive the update request signal for the first member at “11:00”, and transmit the content information with respect to “0003 news” (the partial update (Δ)) to the mobile terminal 210 of the first member. Also, the system 200 for updating the contents may receive the update request signal for the second member at “11:00”, and transmit the content information with respect to “0002 stock” (the partial update (Δ)) and the content information with respect to “0003 news” (the total update (◯)) to the mobile terminal 210 of the second member.

Also, the system 200 for updating the contents may store a membership channel which is classified by the member, a standard time, the inventory information, and the update detail information which is classified by the update type after the update.

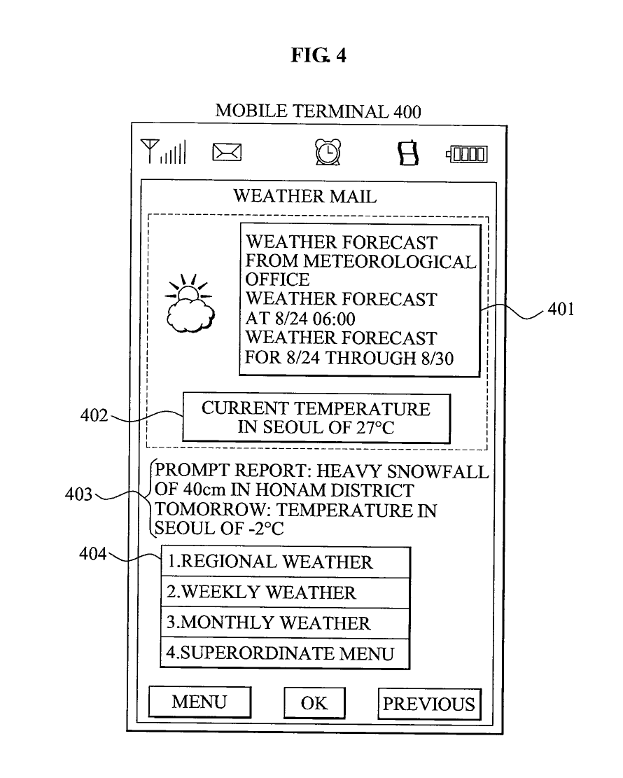

Hereinafter, an example of content display screens is described with reference to FIG. 4.

A mobile terminal 400 provides screens corresponding to sub contents, for example, a watch, a calendar, weather, news, a fortune, a stock, an auction, and a horse race, in a main screen using the content information received from the system 200 for updating the contents according to the present invention. The content information includes each template information for providing each screen, and each template information is a basic frame configuring the content information, and is unchanged at any time. Different from this, the mobile terminal 400 may store and maintain the update information such as real-time information corresponding to the template information for the news screen, a news picture file, a news TEXT, and a Uniform Resource Locators (URL) for a detailed report of the news. Specifically, the mobile terminal 400 may maintain the content information being the basic frame, and provide the member with the news picture file being image data as the update information, the news TEXT providing simple headline information as text data, the detail news URL being URL information which may be used to check a detailed article related to the headline information, and the like.

As illustrated in FIG. 4, the mobile terminal 400 decodes the content information and displays the content information on a display apparatus. Specifically, the mobile terminal 400 receives, from the content provision server 104, information with respect to a currently-displayed forecast, similar to an example (weather information) 401, current temperature information 402 of a specific area, a prompt weather report 403, and news flash information and tomorrow's weather information 403 as the update information. Different from this, the mobile terminal 400 maintains objects which are unchanged in real-time being similar to another example 404, such as a menu displayed on a current screen, as the content information in the storage unit. Accordingly, the content information related to weather may provide real-time information from the content provision server 104, from which the mobile terminal receives the content information, to the member.

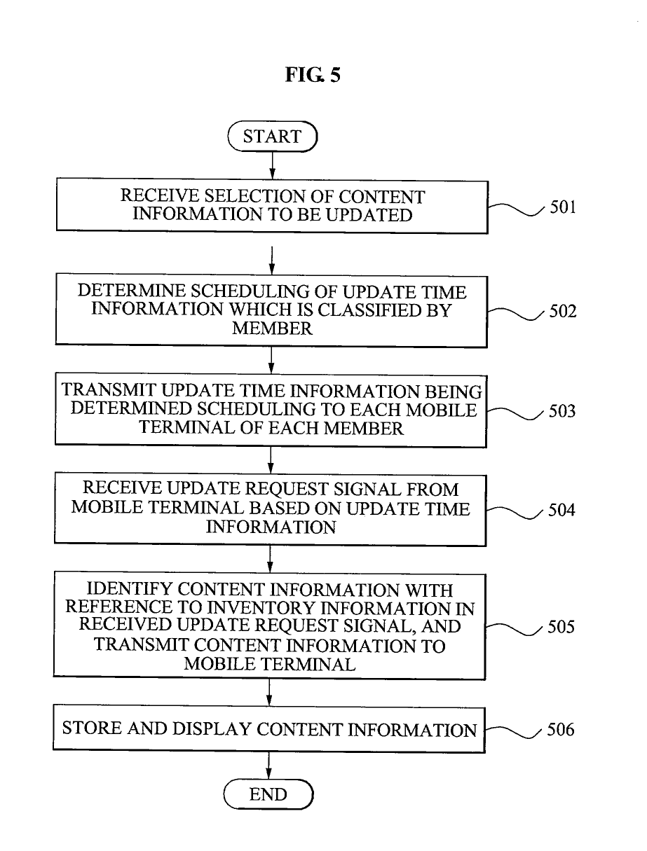

FIG. 5 is a flowchart illustrating a method of updating contents according to an exemplary embodiment of the present invention. The method of updating the contents according to the present exemplary embodiment of the present invention may be performed by the system 200 for updating the contents illustrated in FIG. 2.

First, the content provision server 104 receives, from mobile terminals 101 through 103, a selection of content information to be updated in operation 501. Operation 501 is a process of performing a service registration for a member of the mobile terminal in order to realize an update of the content information according to the present invention.

Also, the system 200 for updating the contents determines scheduling of update time information which is classified by the member in operation 502. The update time information is a time in which the updated contents are transmitted to each mobile terminal of each member, and the system 200 for updating the contents may classify the members into at least two groups, and variously set the update time information for each group.

The system 200 for updating the contents transmits the update time information, the update time being determined scheduling, to each mobile terminal of each member in operation 503. For example, the system 200 for updating the contents may transmit the update time information “9:00” to the mobile terminal 101 of the first group, transmit the update time information “9:10” to the mobile terminal 102 of the second group, and transmit the update time information “9:20” to the mobile terminal 103 of the third group.

The system 200 for updating the contents receives an update request signal from a mobile terminal at a predetermined point in time based on the transmitted update time information in operation 504. In this case, the mobile terminal checks whether a signal transmission time occurs based on the update time information, and when it is determined that the signal transmission time occurs, the mobile terminal generates an update request signal, and is controlled to transmit the update request signal to the content provision server 104. The system 200 for updating the contents may receive inventory information with the update request signal from the mobile terminal.

The system 200 for updating the contents receives the update request signal from the mobile terminal, identifies the content information from the inventory database 203, and transmits the content information to the mobile terminal in operation 505. The inventory database 203 stores the update time information which is classified by each member and the content information corresponding to the inventory information. The content information includes update information and template information. Also, the update information is changed for each update of the content information, and the template information is a basic structure configuring the content information, and is maintained for each update of the content information.

The mobile terminal may perform an update using the content information received from the system 200 for updating the contents. Specifically, the mobile terminal stores and maintains the received content information in a nonvolatile memory of the mobile terminal, and displays the stored content information when a predetermined event is generated, in operation 506.

The predetermined event may be generated when the mobile terminal is converted into a waiting mode, or an input of a soft key included in the mobile terminal exists. Also, the terminal manager application of the mobile terminal displays the stored content information when the event is generated.

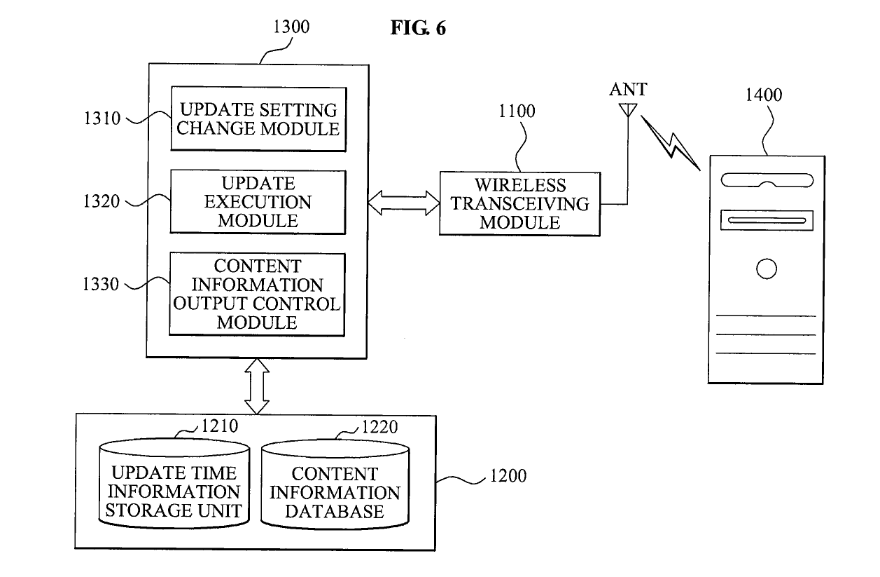

FIG. 6 is a block diagram illustrating a system for updating contents including a mobile terminal and a server for providing an update function according to another exemplary embodiment of the present invention.

Referring to FIG. 6, the system 200 for updating the contents according to the present invention includes a mobile terminal to transmit an update request signal to a server 1400 based on update time information, and to receive, from the server 1400, content information corresponding to the update request signal, and the server 1400 to package the content information corresponding to the update request signal and transmit the content information to the mobile terminal.

The mobile terminal of the present invention includes a wireless transceiving module 1100, a storage module 1200, and a control module 1300.

The wireless transceiving module 1100 transmits an update request signal to the predetermined server 1400 and receives content information from the server 1400. Also, the wireless transceiving module 1100 includes at least one of an antenna (ANT) and a radio frequency (RF) circuit for a wireless communication. Correspondingly, the server packages the content information corresponding to the update request signal and transmits the content information to the mobile terminal.

The storage module 1200 stores update time information for accessing the server 1400 and the content information received from the server 1400. The storage module 1200 includes an update time information storage unit 1210 to store the update time information, and a content information database 1220 to store the content information.

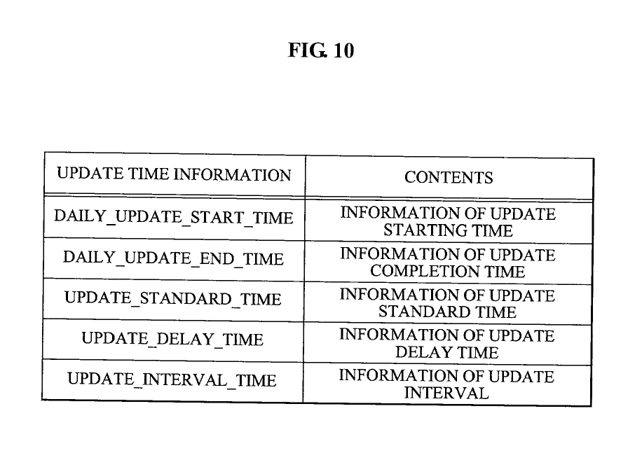

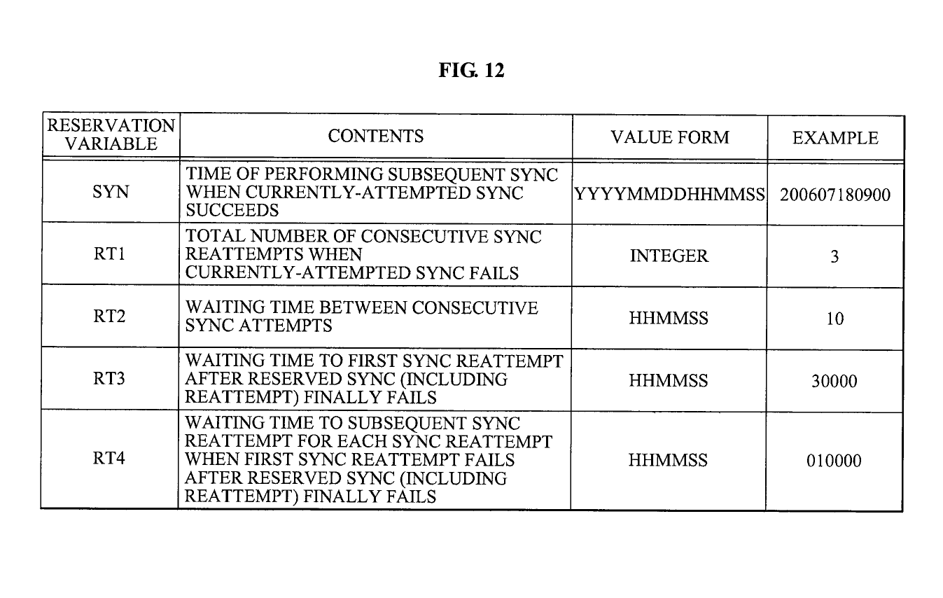

The update time information storage unit 1210 stores the update time information including at least one of an update starting time, an update completion time, a standard time, a delay time from the standard time, and an update interval. The update time information may be set and stored from a point in time of releasing the mobile terminal in a market. Also, the member of the mobile terminal may change the update time information via a predetermined control module later. The update time information is described with reference to FIG. 10. Also, the update time information further includes a reservation variable for reattempting to access when an access to the server 1400 fails. The reservation variable is described below with reference to FIG. 12.

FIG. 10 is a table illustrating update time information including at least one piece of time information according to an exemplary embodiment of the present invention.

Referring to FIG. 10, the update time information of the present invention includes at least one of an update starting time, an update completion time, a standard time, a delay time from the standard time, and an update interval. As illustrated in the table of FIG. 10, the update time information may be expressed as variables corresponding to times included in the update time information. Referring to FIG. 10, the update starting time may be expressed as a Daily_update_start_time variable and include information of an update execution starting time. Also, the update completion time may be expressed as a Daily_update_end_time variable and include information of an update execution completion time. Also, the standard time may be expressed as an Update_standard_time variable and be a standard time in an update execution. The delay time is a delay time of the update execution from the standard time and may be expressed as an Update_delay_time variable. Also, the update interval is an interval from the update execution to the subsequent update execution and may be expressed as an Update_interval_time variable. The member may perform the update using the mobile terminal based on the update time information stored in the mobile terminal, eliminating a need for a separate and consecutive key operation and an access to the server 1400 by driving an event generation of the mobile terminal.

The update standard time is information of time in which the update is executed. Specifically, the update standard time may be calculated based on at least one of the update starting time, the update interval, the delay time, and the update completion time which is set in the update time information. For example, when the update starting time (Daily_update_start_time) of the update time information is set as “9:00” daily, and the update interval (Update_interval_time) is set as two hours, the initial standard time (Update_standard_time) is “9:00”. As the update is progressed, the subsequent standard time is set as a two-hour interval from the initial standard time with reference to the update interval (Update_interval_time).

The delay time (Update_delay_time) is information of delaying the update execution during a time set from the calculated standard time, and when the mobile terminal is released in a market, the delay time may be generally set as 0 (zero). However, the delay time may be changed via a predetermined control module. The delay time may flexibly set an access time to the server 1400 which is classified by the member in order to evenly distribute traffic of the server 1400 as the member increases. In the above-described example, when the delay time (Update_delay_time) is set as five minutes, the initial update standard time (Update_standard_time) may be “9:05”, and the subsequent update standard time (Update_standard_time) may be “11:05”. Subsequently, the update may be executed at the subsequent standard time of “13:05”.

Comparing the standard time with the update completion time (Daily_update_end_time), the update is not executed after the update completion time. As described above, a change of the update standard time (Update_standard_time) may be set by updating with reference to interval information stored in the mobile terminal, or receiving, from the server 1400, the subsequent standard time information with the content information when updating. When the subsequent standard time information is received from the server 1400 when updating, the server 1400 may control, using the above-described delay time (Update_delay_time), a server access time which is classified by the member, considering traffic.

Referring to FIG. 6 again, the content information database 1220 stores the content information, and the content information includes update type information and update detail information. The content information further includes inventory information corresponding to the content information. The inventory information includes a sequence corresponding to the update detail information.

Referring to FIG. 6 again, the control module 1300 controls the mobile terminal to access the server 1400 based on the update time information stored in the storage module 1200, and to receive the content information. The control module 1300 includes an update execution module 1320 to monitor the update time information with reference to the storage module 1200 and transmit the update request signal to the server 1400, and a content information output control module 1330 to access the content information from the storage module 1200 and output the content information to a predetermined display device. Also, the control module 1300 of the present invention further includes an update setting change module 1310 to change the update time information stored in the storage module 1200.

The update setting change module 1310 is a module to change the update time information stored in the storage module 1200 from a point in time of releasing the mobile terminal to market, and any one of the member of the mobile terminal and the server 1400 may change a setting of variables of the update time information by changing setting values such as the update starting time, the update completion time, the standard time, the delay time from the standard time, and the update interval included in the update time information, via the update setting change module 1310 considering a traffic increase based on a member increase.

The update execution module 1320 monitors the update time information with reference to the storage module, and periodically checks the update time information based on the update time information. When a time based on the update time information, for example, the standard time (Update_standard time) occurs, the update execution module 1320 accesses the server 1400 for providing the corresponding information via the wireless transceiving module 1100, receives the content information from the server 1400, and stores the content information in the content information database 1220. Also, when the update of the corresponding information is completed based on the update time information, the wireless transceiving module 1100 and the server 1400 are disconnected.

The content information output control module 1330 accesses the content information from the storage module 1200 and outputs the content information to the predetermined display device.

The mobile terminal receives, from the server 1400, the terminal manager application for receiving the content information, and the terminal manager application is installed in the mobile terminal and controls a session setting between the mobile terminal and the server 1400. The terminal manager application may be provided with basic software installed when the mobile terminal is released to the market. Also, the mobile terminal according to the present invention indicates a portable device such as a portable terminal, a Personal Digital Assistant (PDA), a smart phone, a handheld PC, a mobile phone, and a moving pictures experts group layer 3 (MP3) player, which may include a predetermined wireless communication module such as a Code Division Multiple Access (CDMA) module, a Bluetooth module, and an Infrared Data Association (IrDA) module. Also, the mobile terminal is a general concept of a terminal including a predetermined microprocessor which can perform a certain calculation operation.

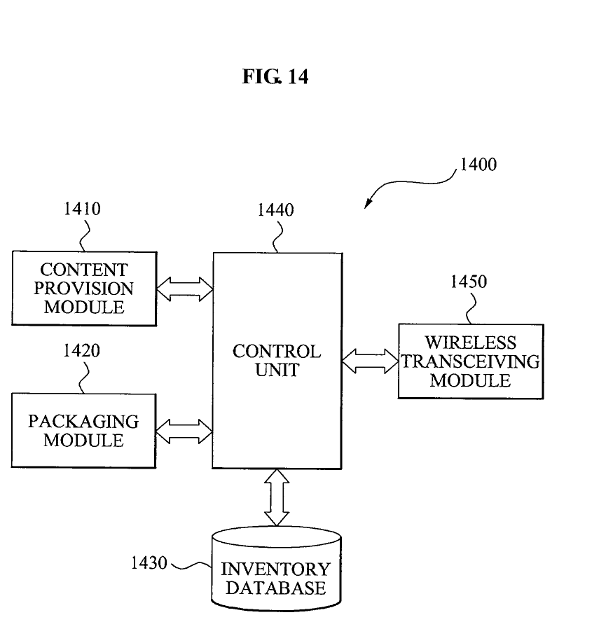

Also, the server 1400 packages the content information corresponding to the update request signal and transmits the content information to the mobile terminal. The server 1400 is described in detail with reference to FIG. 14.

FIG. 14 is a block diagram illustrating components of a server according to an exemplary embodiment of the present invention.

Referring to FIG. 14, the server 1400 of a system for updating contents according to the present invention includes a content provision module 1410 and a packaging module 1420. The content provision module 1410 provides update detail information for the server, and the packaging module 1420 packages content information. Also, the content information includes update type information and the update detail information. The server 1400 packages the content information corresponding to the update request signal from the mobile terminal via the packaging module 1420, and transmits the content information via a wireless transceiving module 1450 to the mobile terminal.

The server 1400 of the system for updating the contents includes an update detail information database (not illustrated) to store and maintain the update detail information from the content provision module, extract the content information corresponding to the update request signal of the mobile terminal from the update database, package the content information, and transmit the content information to the mobile terminal.

Also, the server 1400 of the system for updating the contents according to the present invention further includes an inventory database 1430 to store the inventory information. When information managed by the server 1400 is updated, the server 1400 generates the corresponding inventory information by establishing the update detail information which is classified by the update type updated during a predetermined period as a package object, and stores the inventory information in the inventory database 1430.

Also, the inventory information is generated by the server 1400, or is generated by an external Contents Provider (CP) providing the update detail information. Also, the inventory information may be simultaneously provided via the content provision module 1410 of the server 1400.

As described above, the inventory information corresponds to the content information and is included in the content information transmitted to the mobile terminal. The inventory information is a sequence corresponding to the updated update type information and the update detail information. The server 1400 first transmits only the inventory information stored in the inventory database 1430 when the update request signal of the mobile terminal is received, and the mobile terminal determines whether to update and requests the update to the server 1400.

Also, the server 1400 reads and extracts the inventory information stored in the inventory database 1430 when the update request signal of the mobile terminal is received, determines whether to update with reference to the read and extracted inventory information, and transmits only the necessary information to the mobile terminal. In this case, the server 1400 separately includes an inventory database (not illustrated) corresponding to the content information transmitted being classified by the member of the mobile terminal. Specifically, the server 1400 delete refers to the inventory information which is classified by the member and the inventory information which is read and extracted from the inventory database 1430 when the update request signal of the mobile terminal is received, determines whether to update, and transmits only the necessary information to the mobile terminal based on the determination. Also, the server 1400 may receive, from the mobile terminal, the existing inventory information stored in the mobile terminal, may delete refer to the received inventory information and the inventory information being read and extracted from the inventory database 1430, may determine whether to update, and may transmit only the necessary information to the mobile terminal based on the determination. For this, the inventory information may be expressed as a sequence, and since a transmission control of the content information using the sequence is described in detail above, a detailed description is omitted herein.

The system for updating the contents according to the present invention may efficiently provide the update by using the inventory information and reducing traffic via the above-described configuration.

Also, the server 1400 of the present invention further includes the wireless transceiving module 1450 to receive the update request signal from the mobile terminal and transmit the content information, and a control unit 1440 to control the above-described components.

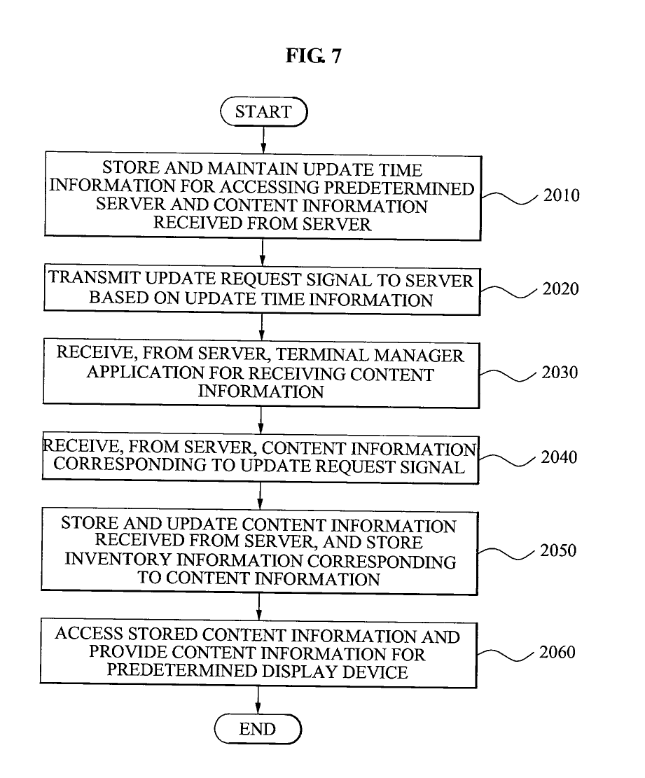

FIG. 7 is a flowchart illustrating a method of updating contents realized in a mobile terminal according to a first exemplary embodiment of the present invention.

Referring to FIG. 7, update time information for accessing the predetermined server 1400 and the content information received from the server are stored and maintained in operation 2010. The update time information includes at least one of an update starting time, an update completion time, a standard time, a delay time from the standard time, and an update interval, and this is similar to the description above with reference to FIG. 6.

Next, an update request signal is transmitted to the server 1400 based on the update time information in operation 2020. The content information corresponding to the update request signal is received from the server in operation 2040.

In this case, when the update request signal is transmitted to the server based on the update time information, only inventory information (a sequence) of the server 1400 is first received. Also, the mobile terminal comparatively refers to the inventory information of the server 1400 and the stored existing inventory information, determines whether to update, and transmits the update request signal to the server 1400.

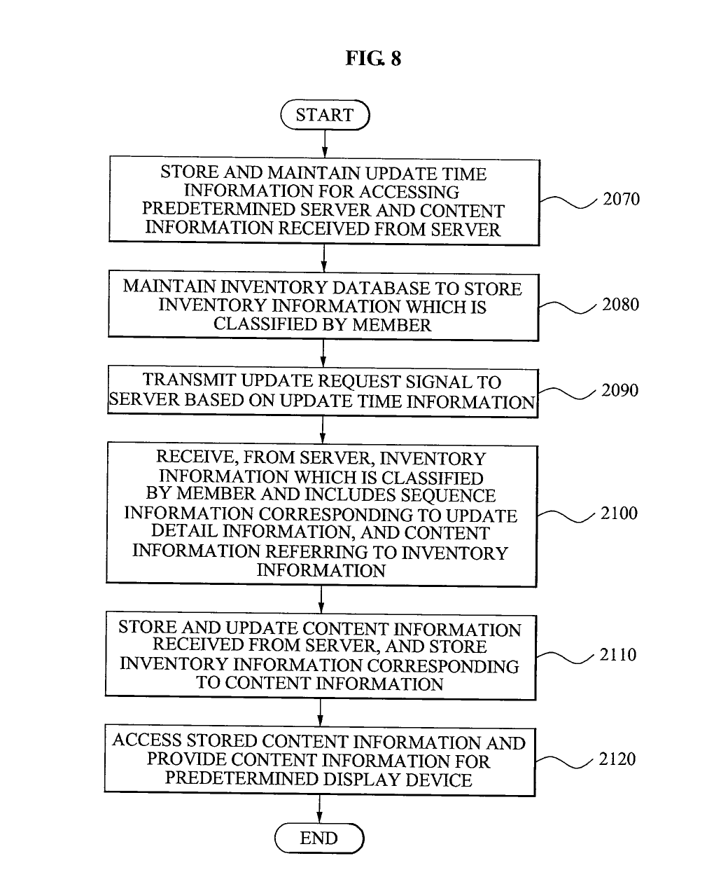

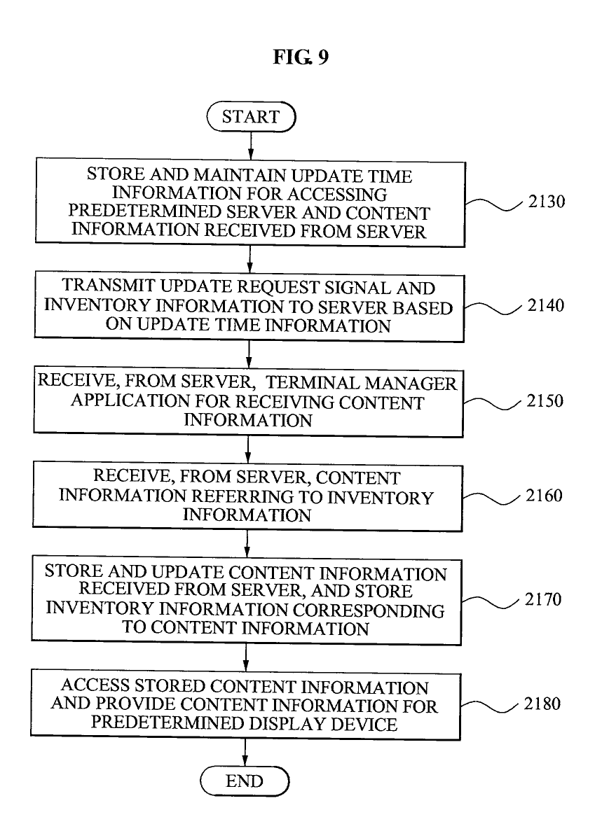

Also, according to the method of updating the contents of the present invention, the server 1400 compares the inventory information which is classified by the member with the inventory information (a sequence) which is read and extracted from the inventory database 1430 when the update request signal is transmitted from the mobile terminal, and determines whether the update is required. Alternatively, when the update request signal is transmitted, the existing inventory information (the sequence) stored in the mobile terminal may be also transmitted, and the server 1400 may comparatively refer to the received inventory information and the inventory information (the sequence) which is read and extracted from the inventory database 1430, determine whether to update, and transmit the necessary information. This is described in detail with reference to FIGS. 8 and 9.

Also, the method of updating the contents realized in the mobile terminal of the present invention may receive, from the server 1400, a terminal manager application for receiving the content information in operation 2030 before the content information corresponding to the update request signal is received from the server, and the terminal manager application is installed in the mobile terminal and controls a session setting between the mobile terminal and the server 1400. Also, the terminal manager application may be provided as basic software installed when the mobile terminal is released to the market.

Later, the content information received from server 1400 is stored and updated, and the inventory information corresponding to the content information is stored in operation 2050.

The content information includes update type information and update detail information, and further includes inventory information corresponding to the content information. The inventory information is a sequence corresponding to the update type information and the update detail information.

Next, the stored content information is accessed, and the content information is provided for a predetermined display device in operation 2060, thereby enabling the content information to be outputted.

FIG. 8 is a flowchart illustrating a method of updating contents realized in a mobile terminal according to a second exemplary embodiment of the present invention.

Referring to FIG. 8, update time information for accessing the predetermined server 1400 and content information received from the server are stored and maintained in operation 2070, and the server 1400 maintains an inventory database to store inventory information which is classified by a member in operation 2080.

Next, an update request signal is transmitted to the server 1400 based on the update time information in operation 2090, and the inventory information which is classified by the member and the content information referring to the inventory information are received, from the server 1400, in operation 2100. Specifically, when the update request signal is transmitted from the mobile terminal, the server 1400 compares the inventory information which is classified by the member with the inventory information (a sequence) which is read and extracted from the inventory database 1430, determines whether the update is required, and transmits the necessary content information to the mobile terminal.

Also, the method of updating the contents of the second exemplary embodiment realized in the mobile terminal of the present invention may receive, from the server 1400, a terminal manager application for receiving the content information before the content information corresponding to the update request signal is received from the server, and the terminal manager application is installed in the mobile terminal and controls a session setting between the mobile terminal and the server 1400.

Next, the content information received from server 1400 is stored and updated, and the inventory information corresponding to the content information is stored in operation 2110. Subsequently, the stored content information is accessed, and the content information is provided for a predetermined display device in operation 2120.

FIG. 9 is a flowchart illustrating a method of updating contents realized in a mobile terminal according to a third exemplary embodiment of the present invention.

Referring to FIG. 9, update time information for accessing the predetermined server 1400 and content information received from the server 1400 are stored and maintained in operation 2130. The update time information includes at least one of an initial access time, a final access time, a standard time, a delay time from the standard time, and an update interval, similar to the description above.

Next, an update request signal and inventory information is transmitted to the server based on the update time information in operation 2140. The content information referring to the inventory information is received from the server 1400 in operation 2160. When the update request signal is transmitted, the existing inventory information (sequence information) stored in the mobile terminal is also transmitted. Also, the server 1400 comparatively refers to the received inventory information and the inventory information which is read and extracted from the inventory database 1430, determines whether to update, and transmits only the necessary information.

Also, the method of updating the contents of the third exemplary embodiment realized in the mobile terminal of the present invention may receive, from the server 1400, a terminal manager application for receiving the content information in operation 2150 before the content information corresponding to the update request signal is received from the server in operation 2160, and the terminal manager application is installed in the mobile terminal and controls a session setting between the mobile terminal and the server 1400.

Next, the content information received from server 1400 is stored and updated, and the inventory information corresponding to the content information is stored in operation 2170. Subsequently, the stored content information is accessed, and the content information is provided for a predetermined display device in operation 2180.

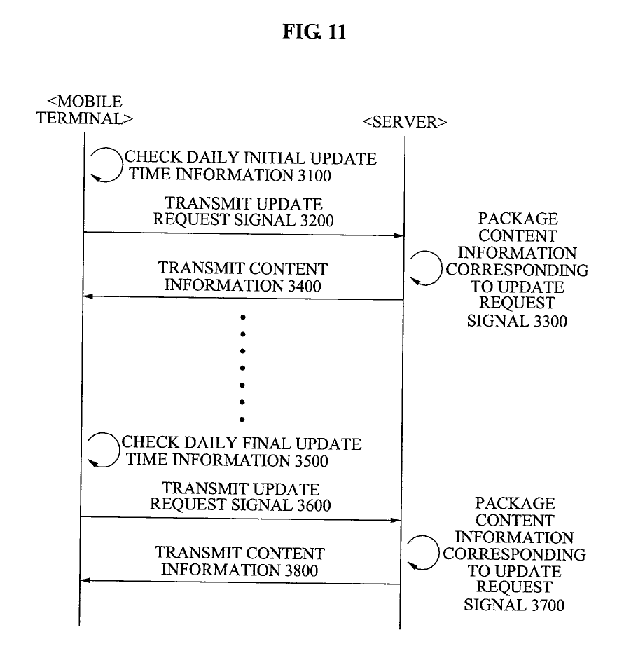

FIG. 11 is a flowchart illustrating a process of transceiving information between a mobile terminal and a server based on update time information according to an exemplary embodiment of the present invention.

Referring to FIG. 11, the mobile terminal checks initial update time information based on the update time information in operation 3100, and an update request signal is transmitted to the server via a wireless transceiving module in operation 3200. For example, when the update starting time (Daily_update_start_time) of the update time information is set as “9:00” daily, the update interval is set as two hours, and the delay time (Update_delay_time) is set as 0 (zero), the update execution module 1320 of the mobile terminal transmits the update request signal to the server 1400 at “9:00”.

The server packages the content information corresponding to the update request signal in operation 3300, and transmits the content information to the mobile terminal, and the mobile terminal receives the content information via the wireless transceiving module in operation 3400.

The standard time is then set as “11:00” being a two-hour interval from the standard time of “9:00”, and the mobile terminal checks the second update interval based on the standard time according to the update time information, and executes the second update at “11:00”.

The update checks the update completion time (Daily_update_end_time) in operation 3500, and compares the standard time with the update completion time (Daily_update_end_time). When the standard time is within the update completion time, the update request signal is transmitted to the server via the wireless transceiving module in operation 3600. Subsequently, the server packages the content information corresponding to the update request signal in operation 3700 and transmits the content information to the mobile terminal, and the mobile terminal receives the content information via the wireless transceiving module in operation 3800. A control module of the mobile terminal stores the received content information in a storage module and completes the update.

FIG. 12 is a table illustrating reservation variables for synchronization between a mobile terminal and a server for a reattempt to access when the mobile terminal fails in an access to the server according to an exemplary embodiment of the present invention.

Referring to FIG. 12, synchronization reservation variables for synchronization between the mobile terminal of the present invention and the server may include a synchronization time variable and a synchronization attempt variable. The synchronization time variable includes synchronization time information (SYN), waiting time information between synchronization attempts (RT2), waiting time information to a first attempt synchronization (RT3), and waiting time information after a second attempt synchronization (RT4). The synchronization attempt variable includes information of a number of synchronization reattempts (RT 1).

The synchronization time information may be expressed as variable SYN, and when the currently-attempted synchronization succeeds, the synchronization time information is related to a time of performing the subsequent synchronization. Also, the synchronization time information may have a value form including a year, a month, a day, an hour, and a minute. The waiting time information between the synchronization attempts may be expressed as variable RT2, is related to a waiting time between consecutively-attempted synchronizations, and includes a value form including an hour, a minute, and a second. Also, the waiting time information to the first attempt synchronization may be expressed as variable RT3, and is related to a waiting time to the subsequent first attempt when the reserved synchronization finally fails or when the reattempted synchronization fails. Variable RT3 may include a value form including an hour, a minute, and a second. Also, the waiting time information after the second attempt synchronization may be expressed as variable RT4, and is related to a waiting time after the subsequent second attempt synchronization when the synchronization of the subsequent first attempt also fails after the reserved synchronization fails, or the reattempted synchronization fails. Variable RT4 may also include a value form of six ciphers including an hour, a minute, and a second. Also, the information of the number of synchronization reattempts may be expressed as variable RT1, and is related to a total number of consecutive synchronization reattempts when the currently-attempted synchronization fails.

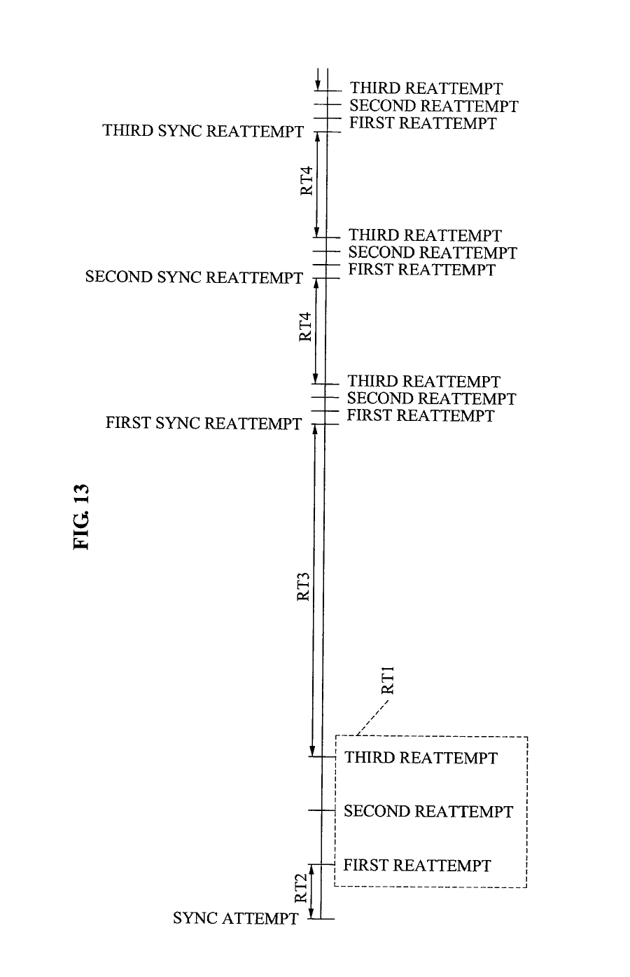

FIG. 13 illustrates a process of performing a synchronization between a mobile terminal and a server for a reattempt when the mobile terminal fails in an access to the server according to an exemplary embodiment of the present invention.

Referring to FIG. 13, the mobile terminal and the server make an attempt of an initial synchronization, and after the initial synchronization succeeds, a subsequently-attempted synchronization may be performed after a time set in variable RT2 being a waiting time. A number of synchronization attempts are determined by a value set in variable RT1. In FIG. 13, when the variable RT1 is set as three, three synchronizations are performed in one attempt. When the synchronization fails in the reserved synchronization attempt, the synchronization of the first attempt is performed after a time set in variable RT3 with respect to the waiting time information to the subsequent first attempt. Three synchronization attempts are made by the time indicated in variable RT1 in the first attempt. When the synchronization fails in the first attempt, the synchronization of the second attempt is made after the time set in variable RT4 with respect to the waiting time after the subsequent second attempt synchronization, when the synchronization of the subsequent first attempt also fails after the time set in variable RT4, that is, after the reserved synchronization fails, or the reattempted synchronization fails. Three synchronization attempts are made by variable RT1 in the second attempt, and synchronizations of the third attempt and the fourth attempt are continuously performed until the synchronization succeeds.

A method of performing the synchronization between the mobile terminal and the server for the reattempt when the mobile terminal fails in accessing the server may be effectively performed using the inventory information. As described above, the inventory information may be expressed as a sequence corresponding to the update detail information. The first method of performing the synchronization first transmits, to the mobile terminal, only the inventory information stored in an inventory database when the update request signal of the mobile terminal is received, determines whether to update, and requests the update to the server.

In the second method of performing the synchronization, when the update request signal is received from the mobile terminal, the server reads and extracts the inventory information stored in the inventory database, determines whether to update with reference to the read and extracted inventory information, and transmits only the necessary information to the mobile terminal.

In the third method of performing the synchronization, the server also receives, from the mobile terminal, and stores the existing inventory information, determines whether to update the inventory information received from the mobile terminal, and transmits the necessary information to the mobile terminal.

The mobile terminal may perform the stable update using the above-described synchronization process between the mobile terminal and the server.

The method of updating the contents according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

A method and system for updating contents according to the present invention enables a mobile terminal to transmit an update request signal to a content provision server based on update time information, and to receive update information from the content provision server when the update time information is determined scheduling which is classified by each member, and is transmitted to each mobile terminal of each member, thereby efficiently updating the contents.

Also, a method and system for updating contents according to the present invention enables a content provision server to determine scheduling of a time of transmitting updated contents to each member, and to transmit the updated content information to a mobile terminal of the member based on the time, the time being determined scheduling, thereby effectively using a mobile network.

Also, a method and system for updating contents according to the present invention may check a content update time via an application and transmit an update request signal to a content provision server when the update time occurs in order to increase a member's convenience when using a mobile terminal.

Also, a method and system for updating contents according to the present invention may provide a member interface displaying content information on a mobile terminal using update information and template information of the content information.

Also, according to the present invention, there may be provided a mobile terminal which can store update information from a point in time of releasing the mobile terminal to market, and a method and system for updating contents which includes the mobile terminal.

Also, according to the present invention, there may be provided a mobile terminal which can perform a stable update using a synchronization process between the mobile terminal and a server.

Also, a method and system for updating contents according to the present invention may automatically perform a stable update based on stored update time information without having to access a server to provide corresponding information via a consecutive input process.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A mobile terminal, the mobile terminal comprising:
a wireless transceiving module to transmit an update request signal to a predetermined server and receive content information from the server;
a storage module to store update time information for accessing the server and the content information received from the server; and
a control module to control the mobile terminal to access the server based on the update time information stored in the storage module, and to receive the content information.

2. The mobile terminal of claim 1, wherein the update time information includes an update standard time, and
the control module controls the mobile terminal to access the server based on the standard time, and to receive the content information.

3. The mobile terminal of claim 2, wherein the update time information further includes standard time setting information, and
the control module sets the standard time with reference to the standard time setting information.

4. The mobile terminal of claim 3, wherein the control module sets the standard time setting information with reference to information received from the server, the information being determined scheduling which is classified by a member.

5. The mobile terminal of claim 3, wherein the standard time setting information includes at least one of an update starting time, an update completion time, an update interval, and a delay time from the standard time.

6. The mobile terminal of claim 2, wherein the control module sets the standard time with reference to subsequent standard time information received from the server when the content information is received.

7. The mobile terminal of claim 2, wherein the update time information further includes a reservation variable for reattempting to access when an access to the server fails.

8. The mobile terminal of claim 1, wherein the content information includes update type information and update detail information.

9. The mobile terminal of claim 8, wherein the content information further includes template information being a basic structure configuring the content information, and being maintained for each update of the content information.

10. The mobile terminal of claim 8, wherein the content information further includes inventory information corresponding to the content information.

11. The mobile terminal of claim 10, wherein the inventory information is a sequence corresponding to the update type information and the update detail information.

12. The mobile terminal of claim 1, wherein the mobile terminal further stores a terminal manager application in the storage module, drives the terminal manager application via the control module, and performs any one of controlling a session setting between the mobile terminal and the server, displaying a graphic of the content information received from the server, and processing a generated event, when displaying the content information received from the server.

13. A system for updating contents, the system comprising:
a mobile terminal to transmit an update request signal to a predetermined server based on update time information, and to receive, from the server, content information corresponding to the update request signal; and
a server to package the content information corresponding to the update request signal and transmit the content information to the mobile terminal.

14. The system of claim 13, wherein the content information packaged by the server includes update type information and update detail information.

15. The system of claim 14, wherein the packaged content information further includes inventory information corresponding to the content information.

16. The system of claim 15, wherein the inventory information is a sequence corresponding to the update detail information.

17. The system of claim 15, wherein the server further includes an inventory database to store the inventory information, and when the update request signal is received, the server reads and extracts the inventory information stored in the inventory database, and transmits the content information with reference to the read and extracted inventory information.

18. The system of claim 13, wherein the update time information includes at least one of an update starting time, an update completion time, a standard time, a delay time from the standard time, and an update interval.

19. The system of claim 13, wherein the server transmits, to the mobile terminal, the update time information being determined scheduling which is classified by a member of the mobile terminal.

20. The system of claim 19, wherein the server receives, from the mobile terminal, a selection of the content information to be updated, and transmits, to the corresponding mobile terminal, the update time information related to the selected content information.

21. A server for providing content information to at least one member mobile terminal, the server comprising:
a content provision module to provide update detail information;
a packaging module to package the content information which includes update type information and the update detail information; and
a control unit to control the server to transmit the packaged content information to the mobile terminal,
wherein the mobile terminal transmits an update request signal to the server based on update time information, and the server transmits, to the mobile terminal, the content information corresponding to the update request signal.

22. A method of updating contents of a mobile terminal, the method comprising:
setting a predetermined server and session based on update time information and transmitting an update request signal by the mobile terminal;
packaging, by the server, content information corresponding to the update request signal, and transmitting, from the server, the content information to the mobile terminal;
receiving and storing the content information corresponding to the update request signal by the mobile terminal; and
displaying the stored content information.
